(19) United States
(12) Patent Application Publication
(10) Pub. No.: US 2005/0018237 A1
(43) Pub. Date: Jan. 27, 2005

(54) Digital transmitter security

(76) Inventors: Travis M. Cossel, Bois, ID (US); Steven G. Henry, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/624,422

(22) Filed: Jul. 22, 2003

(51) Int. Cl. B41J 1/00

(52) U.S. Cl. 358/1.15; 358/400; 713/200; 340/5.8

(57) ABSTRACT

A digital transmitter detects a security code and determines whether a user of the digital transmitter has proper security authorization. The digital transmitter sends data corresponding to printed material scanned into the digital transmitter to one or more destination addresses selected by the user when the user has proper security authorization and implements security measures when the user does not have proper security authorization.

### FIELD OF THE INVENTION

The present invention relates generally to digital transmitters.

### BACKGROUND

Digital transmitters, such as digital senders, digital network copiers, multi-function peripherals, etc., convert printed material, e.g., paper documents, into digital data to be sent to various predefined destinations, e.g., electronic mail (email) addresses, facsimile (fax) destinations (e.g., via LAN fax, Internet fax, etc.), network printers, personal computers, or other data receiving devices. Digital transmitters normally include a scanner for scanning in the printed material for subsequent conversion into digital data by the digital transmitter. One problem is that digital transmitters typically do not provide for guarding against unauthorized sending of data corresponding to the sensitive printed material.

### SUMMARY

An embodiment of the present invention provides a method of operating a digital transmitter. The method includes detecting a security code and determining whether a user of the digital transmitter has proper security authorization. Sending data corresponding to printed material scanned into the digital transmitter to one or more destination addresses selected by the user when the user has proper security authorization and implementing security measures when the user does not have proper security authorization are also included in the method.

### DESCRIPTION OF THE DRAWINGS

FIG. 1 is a block diagram of a digital transmitter according to an embodiment of the present invention.

FIG. 2 is a flow chart of a method according to another embodiment of the present invention.

FIG. 3 is a flow chart of a method according to yet another embodiment of the present invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

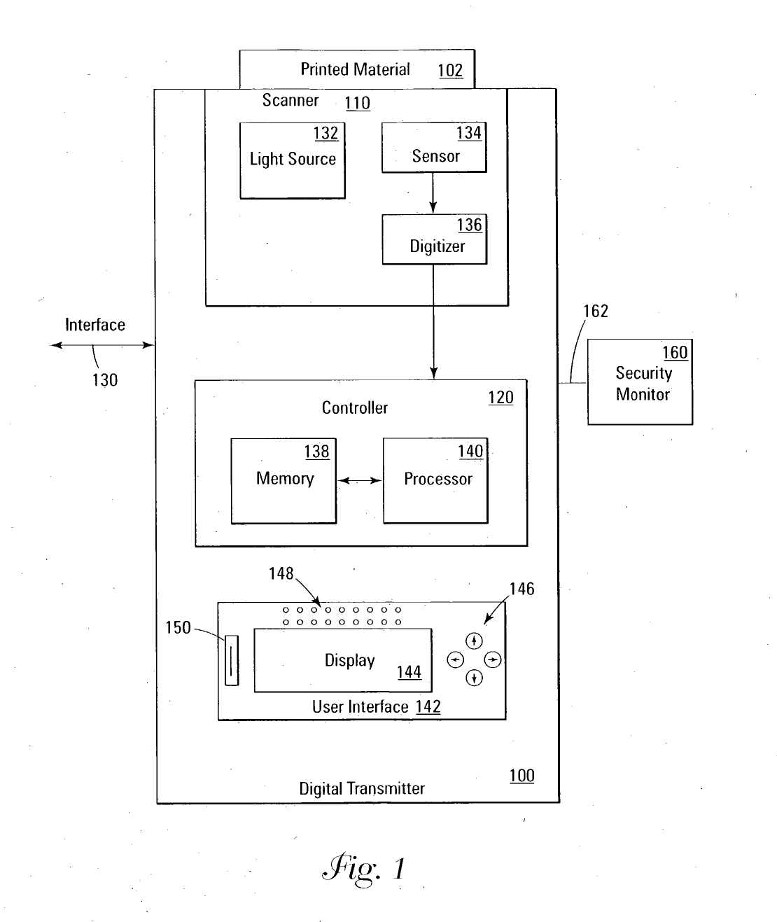

FIG. 1 is a block diagram of a digital transmitter 100, such as a digital sender, digital network copier, multi-function peripheral, etc., according to an embodiment of the present invention. Digital transmitter 100 includes a scanner 110 connected to a controller 120. Scanner 110 converts printed material 102, e.g., printed documents, into digital data that are sent to controller 120. For one embodiment, controller 120 is adapted to format the data received from scanner 110 into a bitmap format. For other embodiments, controller 120 converts the data into a formatted data file, such as Portable Document Format (PDF), Tag Image File Format (TIFF), Joint Photographic Experts Group (JPEG), or other data format, for example, from the bitmap format. Controller 110 is adapted to transmit digital data, e.g., corresponding to the formatted data file, a bitmap, etc., via an interface 122 to one or more destination addresses on a data network. For one embodiment, the destination addresses are network addresses of network devices (printers, servers, workstations, etc.), electronic messaging addresses (e.g., email), facsimile (fax) numbers, etc., and the data network is a Local Area Network, the Internet, or the like. For another embodiment, interface 130 is a network adaptor (or network interface card).

More specifically, for one embodiment, scanner 110 includes a light source 132 and a sensor 134, such as a charged-coupled device (CCD), connected to a digitizer 136, e.g., an analog-to-digital converter. Light source 132 illuminates printed material 102. The light is reflected off of printed material 102 and is received at sensor 134 that converts the reflected light into an analog electrical signal representative of printed material 102. The electronic signal is transmitted to digitizer 136 that converts the analog electrical signal into a digital electrical signal. The digital electrical signal is then transmitted to controller 120.

For one embodiment, controller 110 includes a memory 138, e.g., a computer-usable storage media that can be fixedly or removably attached to digital transmitter 100. Some examples of computer-usable media include static or dynamic random access memory (SRAM or DRAM), read-only memory (ROM), electrically-erasable programmable ROM (EEPROM or flash memory), magnetic media and optical media, whether permanent or removable. Memory 138 may include more than one type of computer-usable media for storage of differing information types.

In various embodiments, memory 138 stores data of the digital signal received from digitizer 136 for subsequent formatting by controller 120. In one embodiment, memory 138 stores the data prior to transmission of the data to the one or more destination addresses on the data network. For another embodiment, memory 138 contains computer-readable instructions, e.g., drivers, adapted to cause a processor 140 of controller 120 to format the data received from scanner 110 and computer-readable instructions to cause processor 140 to cause digital transmitter 100 to perform various methods, as described below.

For one embodiment, digital transmitter 100 includes a user interface 142, such as a graphical user interface, that includes a display 144. For some embodiments, user interface 142 includes arrow keys 146 for navigating display 144, e.g., by scrolling through menu items of display 144, touch-sensitive icons (not shown) corresponding to the menu items of display 144, etc. The computer-readable instructions cause digital transmitter 100 to perform methods in response to the user selecting menu items of display 144, such as scanning printed material 102. For some embodiments, the user can select menu items corresponding to one or more destination addresses, and digital transmitter 100 will send the data corresponding to printed material 102 to these addresses if authorized. For other embodiments, the user can select one or more destination addresses by inputting the addresses using interface keys 148 of user interface 142.

For some embodiments, printed material 102 includes an indicator, such as a watermark, bar code, or the like, e.g., included on each page of a multi-page printed document. The indicator is scanned into digital transmitter 100 and stored as digital data in memory 138 along with printed material 102. For one embodiment, the indicator includes a security code related to the content of printed material 102 and, for example, an identifier for identifying printed material 102, such as a title of printed material 102 etc. The security code may include one or more numbers or letters or may be alphanumeric. For another embodiment, the security code is used to determine a security authorization of the user that may also be expressed in terms of one or more numbers or letters or may be alphanumeric. For other embodiments, the security code is a security level.

For other embodiments, the computer readable instructions cause memory 138 to supply the appropriate security authorization in response to the user logging on to digital transmitter 100; that is, inputting a user identification code, e.g., user name and/or password. The user identification code can be input using interface keys 148 of user interface 142, from a user card via a card reader 150 of user interface 142, etc. For one embodiment, the computer readable instructions cause a prompt to display on display 144 for prompting the user to input the user identification code, for example, before the user can scan printed material 102. For another embodiment, the prompt is displayed in response to the user placing printed material 102 on scanner 110, the user electing to scan printed material 102 by selecting a menu item of user interface 142, etc. Alternatively, the computer readable instructions can cause display 144 to prompt the user to input the security authorization along with the user identification code using interface keys 148.

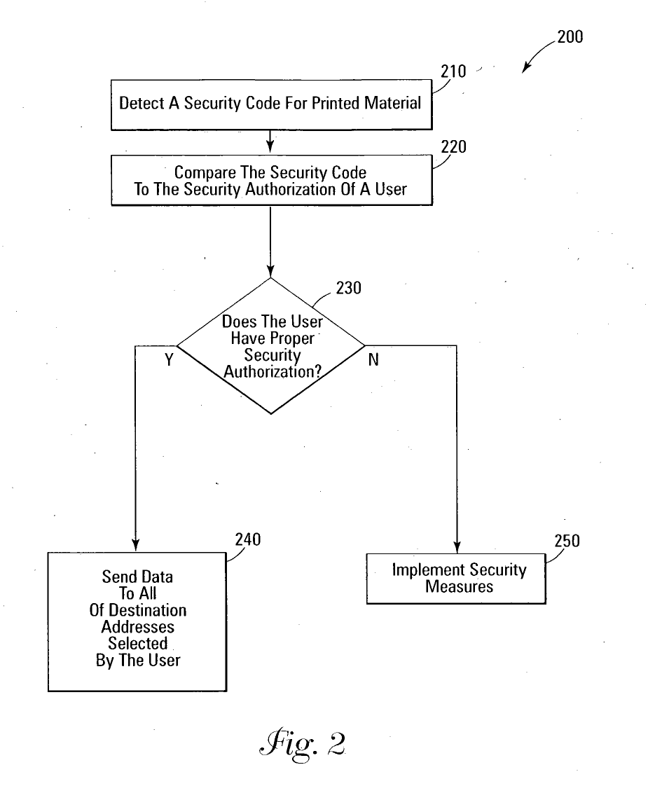

For various embodiments, the computer-readable instructions are adapted to cause digital transmitter 100 to perform a method 200, as illustrated by a flowchart in FIG. 2, in response to scanning printed material 102 and receiving the user's security authorization. At block 210, a security code for printed material 102 is detected on the indicator of printed material 102. For one embodiment, this involves comparing the indicator to a predetermined indicator, e.g., stored in memory 138, and when the indicator and the predetermined indicator match, for example, the security code is detected. The security code for printed material 102 is compared to the security authorization of the user at block 220. For some embodiments, if the security authorization matches or exceeds the security code, it is determined that the user has proper security authorization at decision block 230, and at block 240, the data corresponding to printed material 102 is sent to all of the destination addresses selected by the user.

If it is determined that the user does not have the proper security authorization at block 230, for example, the user's security authorization does not match or exceed the security code, security measures are implemented at block 250. For one embodiment, the security measures include preventing the data from being sent to any of the destination addresses, e.g., by deleting the data. For another embodiment, the security measures include deleting the data or saving the data in memory 138 and sending a security message, indicative of an unauthorized sending attempt, to a destination address of a security monitor 160 for recording security messages. For some embodiments, at least a representative portion of the data is sent to security monitor 160 along with the security message. Security messages may be sent to security monitor 160 with or without notifying the user. Notifying the user of an unauthorized sending attempt may include displaying a message on display 144 or sending an email to the user indicative of the unauthorized sending attempt.

For one embodiment security monitor 160 is located remotely of digital transmitter 100 and is connected to digital transmitter 100 by a data link 162 that may be a hardwired connection or a wireless connection. For another embodiment, security monitor 160 is a computer email box or fax machine of an administrator, such as security personnel or the user's supervisor. For some embodiments security monitor 160 is a voicemail box of the administrator, and the security message sent thereto is an audible message. For another embodiment, security monitor 160 is integrated in digital transmitter 100. For other embodiments, security monitor 160 is accessible through interface 130. For another embodiment, security monitor 160 is a server on a data network.

For other embodiments, the security measures include reviewing the selected destination addresses and sending the data to some of the destination addresses, such as destination addresses approved for the user's security authorization. For one embodiment, approved destinations corresponding to each user's security authorization are stored in memory 138. In these embodiments, a security message may be sent to security monitor 160 that corresponds to attempting to send data to any destinations not approved for the user's security authorization.

For another embodiment, reviewing the selected destination addresses includes looking for a tag on each of the destination addresses indicative of a security authorization for the respective destination address, for example, by comparing the tag to the user's security authorization. When the user's security authorization matches or exceeds the tag of a destination address, the data are sent to that destination address. When the user's security authorization does not match or exceed the tag, a security message may be sent to security monitor 160 indicating that an attempt was made to send data to destinations not approved for the user's security authorization.

For some embodiments, the security code is a keyword or phrase contained within printed material 102, such as text of printed material 102, or a graphical image contained within printed material 102, such as a portion of a drawing or an entire drawing. For these embodiments, data corresponding to scanned printed material 102 is converted into a data file, e.g., by an Optical Character Recognition (OCR) algorithm, a Graphical Image Recognition algorithm, etc. stored in memory 138, that can be searched for the security code (i.e., the keyword or key phrase or key graphical image).

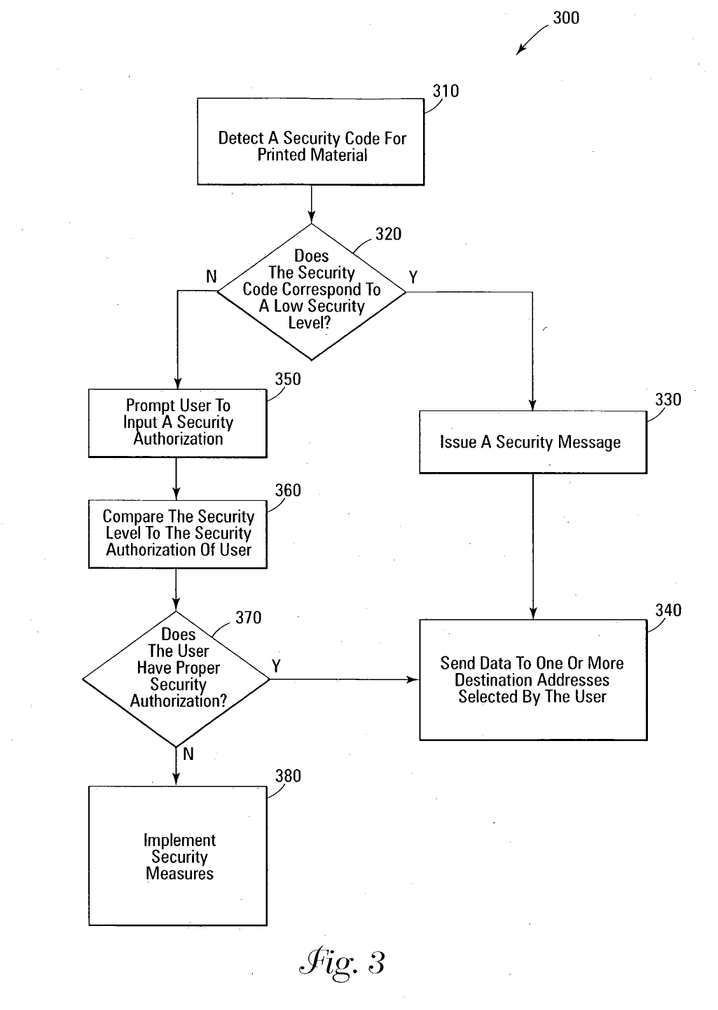

For various embodiments, the computer-readable instructions are adapted to cause digital transmitter 100 to perform a method 300, as illustrated by a flowchart in FIG. 3, e.g., in response to scanning printed material 102. At block 310, a security code for printed material 102 is detected on the indicator of printed material 102 or as a keyword, key phrase, or key graphical image. For one embodiment, this involves comparing text or graphical images within printed material 102 or the indicator of printed material 102 to a number of predetermined security codes (or keywords, key phrases, key graphical images, or indicators), e.g., predetermined by the administrator, stored in memory 138 of digital transmitter 100 or at security monitor 160. For another embodiment, a security code for printed material 102 is detected when the predetermined security code matches text or a graphical image within printed material 102 or the indicator of printed material 102, where the matching text, graphical image, or indicator is the detected security code. For another embodiment, the predetermined security codes correspond to predetermined security levels. For this embodiment, the detected security code corresponds to the security level corresponding to the predetermined security code, e.g., the matching predetermined security code. For other embodiments, the security code is a keyword or key phrase of a subject input by the user for identifying the digital transmitter job containing data corresponding to printed material 102.

For one embodiment, when the security code corresponds to a low security level at decision block 320, digital transmitter issues a security message at block 330. This may include displaying the security message on display 144 and/or sending the security message to the user and/or to security monitor 160. For some embodiments, the security message includes the document title and/or one or more destination addresses for receiving printed material 102. The security message may also include either all or a portion of the printed material. For other embodiments, security monitor records the security message, e.g., for subsequent review by the administrator. Then, at block 340, the data corresponding to printed material 102 is sent to one or more of the destination addresses selected by the user. Specifically, for one embodiment, the data is sent to all of the destination addresses selected by the user. Security messages may be sent to security monitor 160 with or without notifying the user.

For another embodiment, when the security code does not correspond to a low security level at decision block 320, digital transmitter prompts the user to input a security authorization at block 350. The security level corresponding to the security code for printed material 102 is compared to the security authorization of the user at block 360. For some embodiments, if the security authorization matches or exceeds the security level, it is determined that the user has proper security authorization at decision block 370, and at block 340, the data corresponding to printed material 102 is sent to one or more of the destination addresses selected by the user. Specifically, for one embodiment, the data is sent to all of the destination addresses selected by the user. For some embodiments, a security message is sent to security monitor 160 prior to sending the data to the destination addresses. For one embodiment, the security message includes the user's name and an indication that printed material requiring the user's security authorization was sent. The security message may also include the destination addresses, either all or a portion of the printed material, and/or the title of the printed material.

If it is determined that the user does not have the proper security authorization at block 370, for example, the user's security authorization does not match or exceed the security level, security measures are implemented at block 380. For one embodiment, the security measures are as described above for block 250 of FIG. 2.

For various embodiments, the security code includes one of the destination addresses selected by the user for receiving printed material 102, and each of the predetermined security codes includes a destination address that corresponds to a predetermined security level. For example, some organizations may wish to restrict sending data corresponding to printed material 102 by destination address rather than the content of the printed material 102. For these embodiments, method 300 is executed for each of the destination addresses. That is, when one of the destination addresses corresponds to a low security level at decision block 320, a security message is issued at block 330, and at block 340, data corresponding to printed material 340 is sent to that destination address. When another of the destination addresses does not correspond to a low security level at block 320, and the user has the proper security authorization at decision block 370, data corresponding to printed material 340 is sent to that destination address at block 340. Otherwise, the security measures are implemented for that destination address at block 380.

### CONCLUSION

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

1. A method of operating a digital transmitter, the method comprising:
detecting a security code;
determining whether a user of the digital transmitter has proper security authorization;
sending data corresponding to printed material scanned into the digital transmitter to one or more destination addresses selected by the user when the user has proper security authorization; and
implementing security measures when the user does not have proper security authorization.

2. The method of claim 1, wherein detecting the security code comprises detecting one of an indicator, a keyword, a key phrase, or a key graphical image from the printed material.

3. The method of claim 2, wherein detecting an indicator from the printed material comprises detecting a barcode or a watermark from the printed material.

4. The method of claim 1, wherein detecting the security code comprises matching one of the one or more destination addresses with a preselected destination address.

5. The method of claim 1, wherein implementing security measures comprises deleting the data corresponding to the printed material.

6. The method of claim 1, wherein implementing security measures comprises sending the data corresponding to the printed material only to destination addresses of the one or more destination addresses that are approved for the user's security authorization.

7. The method of claim 1, wherein implementing security measures comprises sending a security message to a security monitor.

8. The method of claim 7, wherein sending a security message to a security monitor comprises sending an audible message to a voicemail box.

9. The method of claim 1, wherein implementing security measures comprises notifying the user of an unauthorized sending attempt.

10. The method of claim 9, wherein notifying the user of an unauthorized sending attempt comprises displaying a message indicative of the unauthorized sending attempt on a display of the digital transmitter or sending an email to the user indicative of the unauthorized sending attempt.

11. The method of claim 1, wherein determining whether the user of the digital transmitter has proper security authorization comprises comparing the security code to a security authorization of the user of the digital transmitter.

12. The method of claim 1, further comprising determining a security level of the security code before determining whether the user of the digital transmitter has proper security authorization.

13. The method of claim 1, wherein determining whether the user of the digital transmitter has proper security authorization occurs when the security code does not correspond to a low security level.

14. A computer-usable media containing computer-readable instructions adapted to cause a digital transmitter to perform a method, the method comprising:
detecting a security code;
determining whether a user of the digital transmitter has proper security authorization;
sending data corresponding to printed material scanned into the digital transmitter to one or more destination addresses selected by the user when the user has proper security authorization; and
implementing security measures when the user does not have proper security authorization.

15. The computer-usable media of claim 14, wherein, in the method, detecting the security code comprises detecting one of an indicator, a keyword, a key phrase, or a key graphical image from the printed material.

16. The computer-usable media of claim 14, wherein, in the method, implementing security measures comprises sending the data corresponding to the printed material only to destination addresses of the one or more destination addresses that are approved for the user's security authorization.

17. The computer-usable media of claim 14, wherein, in the method, determining whether the user of the digital transmitter has proper security authorization comprises comparing the security code to a security authorization of the user of the digital transmitter.

18. The computer-usable media of claim 14, wherein the method, further comprises determining a security level of the security code before determining whether a user of the digital transmitter has proper security authorization.

19. A digital transmitter comprising:
a scanner adapted to convert printed material into digital data; and
a controller connected to the scanner for receiving the digital data, the controller adapted to transmit the digital data to one or more destination addresses selected by a user of the digital transmitter, the controller further adapted to cause the digital transmitter to perform a method, the method comprising:
detecting a security code from the digital data;
determining whether a user of the digital transmitter has proper security authorization;
sending the digital data to all of the one or more destination addresses selected by the user when the user has proper security authorization; and
implementing security measures when the user does not have proper security authorization.

20. The digital transmitter of claim 19, further comprising a security monitor.

21. The digital transmitter of claim 19, wherein, in the method, detecting the security code comprises detecting one of an indicator, a keyword, key phrase, or a key graphical image from the printed material.

22. A digital transmitter comprising:
means for converting scanned printed material into digital data;
means for detecting a security code from the digital data;
means for determining whether a user of the digital transmitter has proper security authorization;
means for sending the digital data to all of one or more destination addresses selected by the user when the user has proper security authorization; and
means for implementing security measures when the user does not have proper security authorization.

23. A method of operating a digital transmitter, the method comprising:
detecting a security code;
determining a security level of the security code;
issuing a security message when the security level of the security code is low; and
sending data corresponding to printed material scanned into the digital transmitter to one or more destination addresses selected by a user of the digital transmitter.

24. The method of claim 23, wherein detecting the security code comprises detecting one of an indicator, a keyword, key phrase, or a key graphical image from the printed material.

25. The method of claim 23, wherein determining the level of the security code comprises matching the security code to a predetermined security code that corresponds to a preselected security level.

26. The method of claim 23, wherein issuing the security message comprises sending the security message to at least one of the user and a security monitor.

27. The method of claim 23, wherein issuing the security message comprises displaying the security message at the digital transmitter.

28. The method of claim 23, further comprising prompting the user to input a security authorization when the security level of the security code is not low.

29. A method of operating a digital transmitter, the method comprising:
detecting a security code from printed material scanned into the digital transmitter;
when the security code corresponds to a low security level, issuing a security message; and
sending data corresponding to printed material scanned into the digital transmitter to all of one or more destination addresses selected by a user of the digital transmitter; and
when the security code does not correspond to a low security level,
comparing the security level to a security authorization of the user to determine whether the user has proper security authorization;
sending the data corresponding to the printed material to all of the one or more destination addresses selected by the user when the user has proper security authorization; and
implementing security measures when the user does not have proper security authorization.

30. The method of claim 29, wherein detecting the security code comprises detecting one of an indicator, a keyword, key phrase, or a key graphical image from the printed material.
